(19) United States
(12) Patent Application Publication
(10) Pub. No.: US 2017/0076375 A1
(43) Pub. Date: Mar. 16, 2017

(54) Margin Requirements for Multi-Currency CDS Portfolios

(71) Applicant: Chicago Mercantile Exchange, Inc., Chicago, IL (US)

(72) Inventors: Evren Baysal, Chicago, IL (US); Panagiotis Xythalis, Scotch Plains, NJ (US); Kailin Ding, Chicago, IL (US); Sixiang Li, Chicago, IL (US); Lu Lu, Pittsburgh, PA (US); Jun Zhai, Chicago, IL (US)

(21) Appl. No.: 14/849,904

(22) Filed: Sep. 10, 2015

(51) Int. Cl. G06Q 40/06

(52) U.S. Cl. CPC G06Q 40/06

(57) ABSTRACT

A computer system may calculate margin component values for a multi-currency credit default swap (CDS) portfolio. The portfolio may include a portion having positions corresponding to CDSs denominated in a first currency and a portion having positions corresponding to CDSs denominated in a second currency. Some of the calculated margin component values may be in terms of the first currency and some of the calculated margin component values may be in terms of the second currency. The calculated margin component values may be used to determined a margin requirement in the first currency and a margin requirement in the second currency.

### BACKGROUND

A credit default swap (CDS) is a financial product that may be used to hedge risk and/or for other purposes. A CDS can take several forms. As the name implies, a “single name” CDS names a single corporation or other credit entity. A buyer of a single name CDS agrees to make one or more payments to the seller of that CDS. The amount of those payments may be negotiated between the buyer and the seller and is akin to the CDS purchase price. In return for the agreed-upon payments, the CDS seller agrees to make a designated payout if the credit entity named by the CDS goes into default during the tenor of that CDS. Default events may be defined by the CDS and may include, e.g., bankruptcy, failure to pay debts, etc.

An index CDS names multiple credit entities, with that collection of entities sometimes known as a “basket.” For example, some types of index CDS may name a basket of 100 or more different corporations. As with a single name CDS, an index CDS buyer agrees to make one or more payments to the seller. In return for those payments, the seller agrees to make a designated payment for each of the named entities (or “names”) of the CDS that goes into default during the CDS tenor.

At any given time during its tenor, an executed CDS (i.e., a CDS that has been entered into by a buyer and a seller) has a market value. For example, assume that a buyer of a single name CDS relating to XYZ Co. agrees to pay $100 to the seller. Further assume that, at some time after the buyer and the seller execute that CDS, the credit-worthiness of XYZ Co. deteriorates. Because of that deterioration, the market price of a CDS to obtain similar protection against XYZ Co. default is now $110. For the buyer who paid $100 for the executed single name CDS naming XYZ Co., the buyer's position in that executed CDS has gained value. Conversely, the seller's position in that executed CDS has lost value. If XYZ Co. were to default, the value of the buyer's position in the executed CDS would jump to the amount of the agreed payout, less the original purchase price. The value of the seller's position would vary in the opposite direction upon XYZ Co. default.

Values of buyer and seller positions in a CDS can also vary in other ways. For instance, assume that the credit worthiness of XYZ Co. improves after execution of the CDS from the previous example. Because of that improvement, the new market price for similar CDS naming XYZ Co. may have dropped to $90. This would represent a decrease in the value of the buyer's position in the executed CDS and an increase in the value of the seller's position.

The value of a position in an executed index CDS can vary in ways similar to those described above. However, the effect of any one name on the value of an index CDS position is much less than in the case of a single name CDS position.

A CDS may be cleared so as to protect against a default by the buyer or seller of that CDS. After execution of a CDS by a buyer and seller, for example, a clearinghouse may perform a novation and a become party to multiple credit default swaps (CDSs) with the buyer and seller. In particular, the CDS between the buyer and seller is replaced with a first CDS between the buyer and the clearinghouse as seller, and an identical second CDS between the seller and the clearinghouse as buyer. In practice, a clearinghouse may deal with firms known as clearing members (or “members”). Each member may act for itself and/or on behalf of multiple other parties. As a result, each member may have a large portfolio of CDSs that are cleared through a clearinghouse. In any given portfolio, a member may have positions in multiple different types of CDSs. Some positions may be as a buyer, and some positions may be as a seller.

To help ensure that a member fulfills its obligations under CDSs in its portfolio, a clearinghouse may require the member to provide a margin payment. This margin payment represents a security or performance bond. This is distinguishable from the use of the term “margin” in connection with securities trading, where margin refers to a partial payment of a purchase price. As used herein, the term “margin” refers to a security or performance bond associated with CDS clearing.

A CDS may be denominated in any of multiple currencies. For example, CDX is a name for a family of index CDS products with baskets of North American credit entities, and for which the buyer and seller payments are in U.S. dollars (USD). As another example, iTraxx® is a brand name for a family of index CDS products having baskets of credit entities from other regions, and for which buyer and seller payments are in Euros (EUR). A clearinghouse member may have a portfolio that includes CDS products denominated in more than one currency. Determining an appropriate margin for such a portfolio presents problems not addressed by known systems

### SUMMARY

This Summary is provided to introduce a selection of concepts in a simplified form that are further described below in the Detailed Description. This Summary is not intended to identify key features or essential features of the invention.

In a method according to some embodiments, a computer system may access data describing positions of a multi-currency CDS portfolio PF. The portfolio PF may include a portfolio portion PF₁ comprising positions in CDS products denominated in a first currency and a portfolio portion PF₂ comprising positions in CDS products denominated in a second currency. The computer system may calculate, based on the accessed data and on an exchange rate FX₂₁_{_}_{UP} for converting the second currency to the first currency, a first margin component in the first currency. The computer system may also calculate, based on the accessed data and on an exchange rate FX₂₁_{_}_{DN} for converting the second currency to the first currency, a second margin component in the first currency, wherein FX₂₁_{_}_{UP} is greater than FX₂₁_{_}_{DN}. The computer system may additionally calculate a margin component MC1 as a maximum of a set of values that includes the first margin component and the second margin component. The computer system may further calculate, based on the accessed data, a margin component MC2₁ in the first currency, a margin component MC2₂ in the second currency, a first currency margin requirement MR₁ as a sum of the margin component MC2₁ and a portion of the margin component MC1 corresponding to the portfolio portion PF₁, and a second currency margin requirement MR₂ as a sum of the margin component MC2₂ and a portion of the margin component MC1 corresponding to the portfolio portion PF₂. The computer system may transmit data representing the first currency margin requirement MR₁ and the second currency margin requirement MR₂.

Embodiments include, without limitation, methods for calculating and otherwise processing data related to margin requirements for multi-currency CDS portfolios, computer systems configured to perform such methods and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing systems and methods according to at least some embodiments.

FIG. 2 is a flow chart showing steps in a method according to some embodiments.

FIGS. 3A through 4B are flow charts showing additional operations associated with various steps in the flow chart of FIG. 2.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

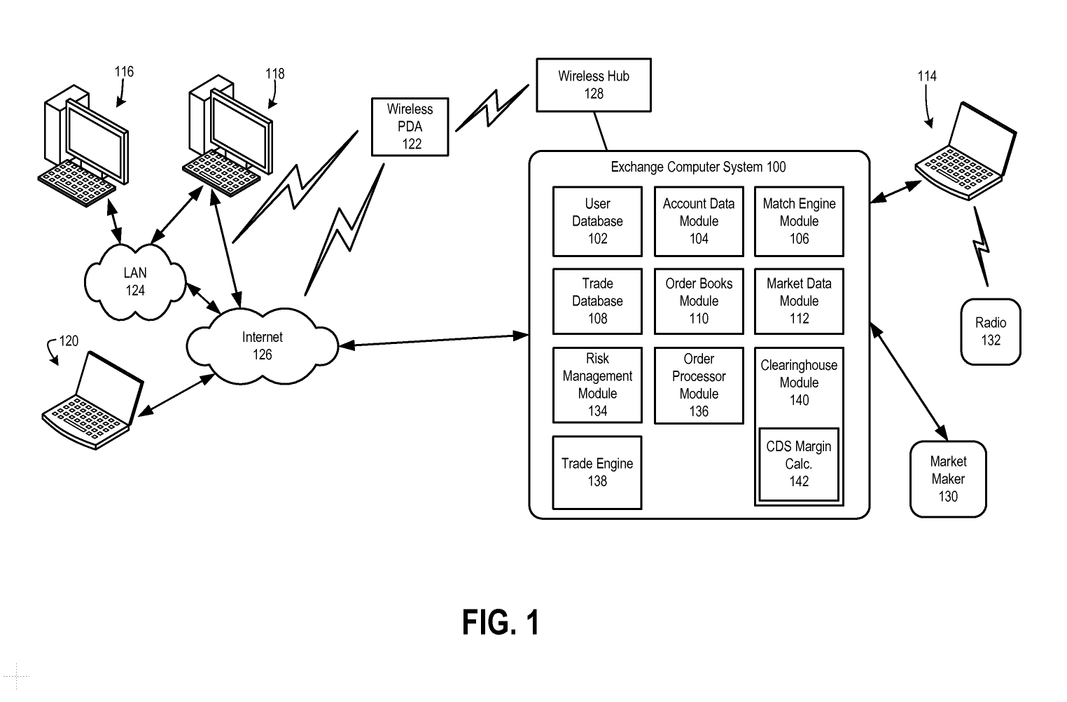

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with calculation and implementation of margin requirements for CDS portfolios.

Computer system 100 can be operated by a financial product exchange and configured to perform operations of the exchange for, e.g., trading and otherwise processing various financial products. Financial products of the exchange may include, without limitation, futures contracts, options on futures contracts, other types of options, and other types of derivative contracts. Financial products traded, cleared, and/or otherwise processed by the exchange may also include CDSs. Financial products traded through the exchange may also or alternatively include other types of financial products, including without limitation stocks, bonds and or other securities (e.g., exchange traded funds), foreign currencies, spot market trading of commodities, and over-the-counter (OTC) products such as OTC forwards, OTC options, OTC interest rate swaps, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse associated with the exchange that operates computer system 100. Module 140 may receive data from and/or transmit data to trade database 108 and/or other modules of computer system 100 regarding trades of CDSs and other financial products traded through the exchange that operates system 100. Clearinghouse module 140 may facilitate the financial product exchange (or a clearinghouse of the exchange) acting as one of the parties to every traded CDS or other product. Module 140 may also be configured to perform other clearinghouse operations. As a further example, module 140 may maintain margin data with regard to clearing members. As part of such margin-related operations, module 140 may store and maintain data regarding the values of various CDSs and other interests, determine mark-to-market and final settlement amounts, confirm receipt and/or payment of amounts due from margin accounts, confirm satisfaction of final settlement obligations, etc. CDS margin calculation module 142 may also generate, store, and process data regarding margins for multi-currency CDS portfolios. Various operations performed by module 142 in at least some embodiments are further described below.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Also shown in FIG. 1 is a radio 132. The user of radio 132 (e.g., a trader or exchange employee) may transmit orders or other information to a user of computer device 114. The user of computer device 114 may then transmit those orders or other information to exchange computer system 100 using computer device 114.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118, and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, module 142 and/or other modules of exchange computer system 100 may include one or more non-transitory computer-readable media storing computer-executable instructions for performing herein-described operations.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates, and/or otherwise processes data in connection with margins for multi-currency CDS portfolios. In some embodiments, some or all of these operations may be performed by CDS margin calculation module 142. In other embodiments, one or more other modules of computer system 100 may perform some or all of these operations. In still other embodiments, one or more of these operations could be performed by a computer system that is separate from computer system 100.

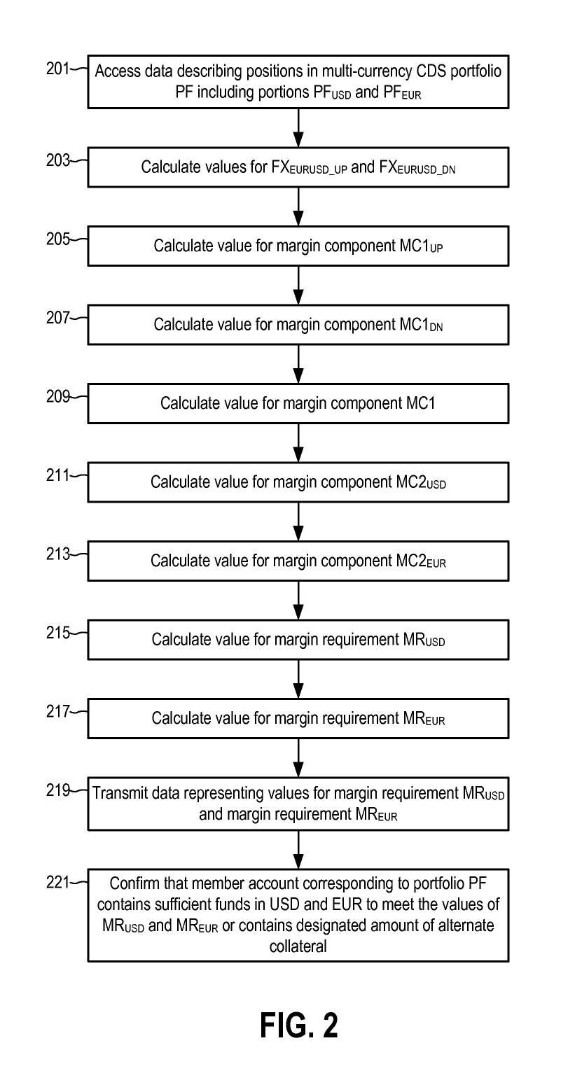

FIG. 2 is a flow chart showing operations performed by computer system 100 in some embodiments. For convenience, FIG. 2 will be described in the context of a multi-currency CDS portfolio in which a first currency is U.S. Dollars (USD), i.e., a first portion of the portfolio includes interests in CDSs denominated in USD. A second currency in the multi-currency CDS portfolio is Euros (EUR), i.e., a second portion of the portfolio includes interests in CDSs denominated in EUR. Subscripts “_{USD}” and “_{EUR}” are used where appropriate to respectively refer to elements related to the first and second currency. In other embodiments, the first currency may be a currency other than USD and/or the second currency may be a currency other than EUR.

In step 201, module 142 accesses data describing positions in a multi-currency CDS portfolio PF. Portfolio PF includes positions in multiple types of CDS products. A “position” refers rights as a buyer or as a seller in a corresponding executed CDS product having defined parameters such as named credit entity(ies), default definitions, payout amounts, tenor, etc., and also having an agreed-upon price. A portion PF_{USD} of portfolio PF includes positions in CDS products denominated in USD. A portion PF_{EUR} of portfolio PF includes positions in CDS products denominated in EUR. For convenience, “credit entity[ies] named in a position,” or the like, is used below as a shorthand reference to describe credit entity[ies] named in a CDS corresponding to a position.

In step 203, module 142 calculates FX_{EURUSD}_{_}_{UP} and FX_{EURUSD}_{_}_{DN}, where each of FX_{EURUSD}_{_}_{UP} and FX_{EURUSD}_{_}_{DN} is an exchange rate for converting EUR to USD, with FX_{EURUSD}_{_}_{UP} being greater than FX_{EURUSD}_{_}_{DN}. To calculate FX_{EURUSD}_{_}_{UP} and FX_{EURUSD}_{_}_{DN}, module 142 first calculates a value ΔFX_{EURUSD} by taking the 99% quantile of 5-day log changes of the spot EUR-to-USD exchange rate standardized by exponentially weighted moving average volatility. Module 142 then calculates FX_{EURUSD}_{_}_{UP} and FX_{EURUSD}_{_}_{DN} by applying ΔFX_{EURUSD} to the current EUR-to-USD spot rate (FX_{EURUSD}_{_}_{Spot}).

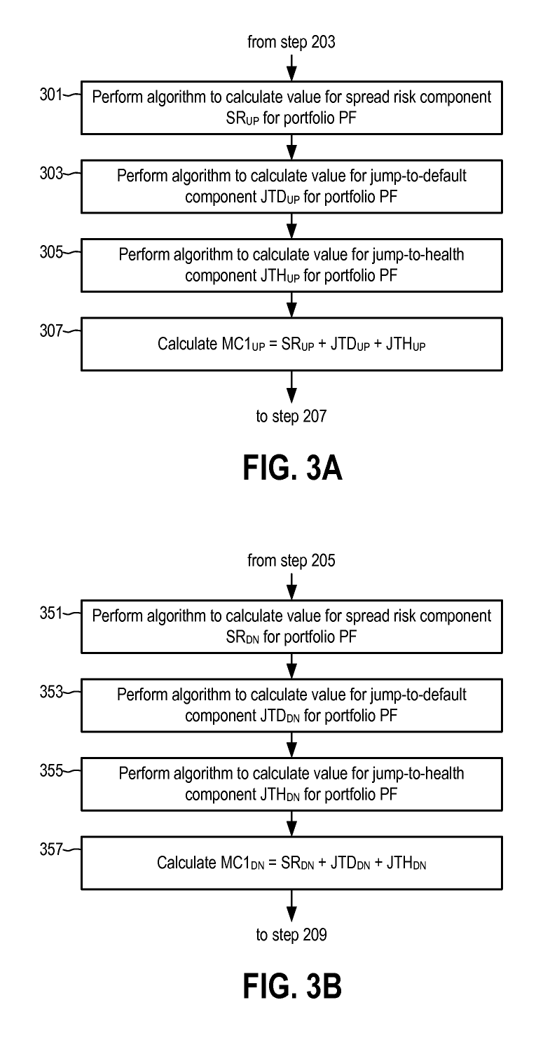

In step 205, module 142 calculates a margin component MC1_{UP} using a first set of one or more algorithms and based on the positions in portfolio PF (PF positions). Margin component MC1_{UP} is calculated in USD. FIG. 3A shows operations of step 205 according to some embodiments.

In step 301, module 142 performs an algorithm to calculate a value for a spread risk component SR_{UP} for the PF positions. Spread risk component SR_{UP} represents a 99th percentile estimate of an amount that the value of portfolio PF might change over a predetermined period (e.g., 5 days) as a result of changes in the value of CDSs corresponding to PF positions, but without considering possible default events, and assuming an exchange rate of FX_{EURUSD}_{_}_{UP}. In some embodiments, the algorithm of step 301 generates N scenarios using a Monte Carlo simulation calibrated to historical data, with N=10,000 scenarios n=1 through n=10,000. In each scenario, a 5-day change in the value of each PF position is estimated. In other embodiments, there may be more or fewer scenarios and/or a different simulation model may be used. For each n^{th} scenario, a value of SR_{UP}(n) is calculated in USD according to SR_{UP}(n)=SR_{USD}(n)+FX_{EURUSD}_{_}_{UP}*SR_{EUR}(n), where SR_{USD}(n) is an estimate of a 5-day value change (in USD) for the positions in portion PF_{USD} of portfolio PF according to scenario n, and wherein where SR_{EUR}(n) is an estimate of a 5-day value change (in EUR) for the positions in portion PF_{EUR} of portfolio PF according to scenario n. SR_{UP} is then set to equal the 99th percentile value from the 10,000 values of SR_{UP}(n) calculated for n=1 through n=10,000.

In step 303, module 142 performs an algorithm to calculate a value for a jump-to-default component JTD_{UP} for the PF positions. The jump-to-default component JTD_{UP} represents an estimate of the largest possible loss that might result from a default by a single credit entity named by one or more of the PF positions, and assuming an exchange rate of FX_{EURUSD}_{_}_{UP}. In some cases, a given credit entity may be named in multiple PF positions. Some of those positions may correspond to single name CDSs, and some may correspond to index CDSs. Those positions may also include buyer positions and seller positions. As can be appreciated, the default of a single credit entity may increase the value of some positions and may decrease the value of other positions.

In some embodiments, JTD_{UP} is calculated in USD and may estimate losses, apart from spread risk losses, that may result from a default of a single one of the entities represented in portfolio PF. In some such embodiments, and for each of j credit entities named in one or more of the PF positions, the algorithm of step 303 first calculates a value JTD_{UP}(j). The value for JTD_{UP}(j) represents an exposure of portfolio PF if there is a default of the j^{th} credit entity and payouts are made based on that default. In some embodiments, JTD_{UP}(j) value may equal the sum of (1) the mark-to-market (MTM) values, as of default, for all PF positions corresponding to a single name CDS naming the j^{th} credit entity, and (2) the MTM values, as of default, for all PF positions corresponding to an index CDS position including the j^{th} credit entity as a constituent, but with each of those index CDS positions assumed to have a notional equal to 1/R of the index CDS position actual notional (as of the time of JTD_{UP}(j) calculation), with R being the number of names in the corresponding index CDS. If the j^{th} entity is denominated in USD, then (1) and (2) are initially calculated in USD. If the j^{th} entity is denominated in EUR, then (1) and (2) may be initially calculated in EUR and converted to USD using FX_{EURUSD}_{_}_{UP}. Depending on the nature of each PF position naming the naming the j^{th} credit entity, the value of JTD_{UP}p(j) could be positive or negative.

The algorithm of step 303 then computes a value L* representing the largest loss at 99% confidence level in any scenario involving a default of a single credit entity named in one or more of the PF positions. This calculation may be performed according to Equation 1.

$${L}^{*} = - {min}_{j} ( {JTD}_{UP} ( j ) - {SR}_{UP} ( j ) ) \qquad Equation 1$$

In Equation 1, “SR_{UP}(j)” is a value for spread risk calculated using the same N scenarios used in connection with step 301, but for a portfolio PFₙₒ_{_}ⱼ that is similar to portfolio PF, but with all single name positions naming the j^{th} entity excluded and with notionals of all index positions having a basket that includes the j^{th} entity adjusted to exclude the j^{th} entity. SR_{UP}(j) is set to equal the 99th percentile value from the 10,000 values of SR_{UP}(j,n)=SR_{USD}(j,n)+FX_{EURUSD}_{_}_{UP}*SR_{EUR}(j,n) calculated for n=1 through n=10,000, where SR_{UP}(j,n) is a value for spread risk of portfolio PFₙₒ_{_}ⱼ under scenario n, SR_{USD}(j,n) is a value for spread risk of the USD-denominated portion of portfolio PFₙₒ_{_}ⱼ under scenario n, and SR_{EUR}(j,n) is a value for spread risk of the EUR-denominated portion of portfolio PFₙₒ_{_}ⱼ under scenario n. The value of jump-to-default component JTD_{UP} may then calculated according to Equation 2, where SR_{UP} is the value from step 301.

JTD_{UP}=max((L*−SR_{UP}), 0) Equation 2

In step 305, module 142 performs an algorithm to calculate a value for a jump-to-health component JTH_{UP} for the PF positions. The jump-to-health component JTH_{UP} is used to account for a large, idiosyncratic move in any single name spread, and assuming an exchange rate of FX_{EURUSD}_{_}_{UP}. JTH_{UP} may be calculated in USD. In some embodiments, and for each of j credit entities named in one or more PF positions corresponding to a single name CDS, the algorithm of step 305 calculates a net value JTH_{UP}(j) of all PF positions corresponding to a single name CDS naming the j^{th} credit entity. These net values are calculated by assuming the spreads for the single name CDSs corresponding to those positions take values given by their 0.5% quantiles. If the j^{th} entity is denominated in USD, then JTH_{UP}(j) may initially be calculated in USD. If the j^{th} entity is denominated in EUR, then then JTH_{UP}(j) may be initially calculated in EUR and converted to USD using FX_{EURUSD}_{_}_{UP}.

The algorithm of step 305 then computes a value L**, representing the largest loss at 99% confidence level in any scenario with a JTH event. This value may be calculated according to Equation 3.

$${{L}^{*}}^{*} = - {min}_{j} ( {JTH}_{UP} ( j ) - {SR}_{UP}^{′} ( j ) ) \qquad Equation 3$$

In Equation 3, “SR′_{UP}(j)” is a value for a spread risk calculated using the same N scenarios used in connection with step 301, but for a portfolio PF′ₙₒ_{_}ⱼ that is similar to portfolio PF, but with all single name positions naming the j^{th} entity excluded. SR′_{UP}(j) is set to equal the 99th percentile value from the 10,000 values of SR′_{UP}(j,n)=SR′_{USD}(j,n)+FX_{EURUSD}_{_}_{UP}*SR′_{EUR}(j,n) calculated for n=1 through n=10,000, where SR′_{UP}(j,n) is a value for spread risk of portfolio PF′ₙₒ_{_}ⱼ under scenario n, SR′_{USD}(j,n) is a value for spread risk of the USD-denominated portion of portfolio PF′ₙₒ_{_}ⱼ under scenario n, and SR′_{EUR}(j,n) is a value for spread risk of the EUR-denominated portion of portfolio PF′ₙₒ_{_}ⱼ under scenario n. The value of jump-to-default component JTH_{UP} may then be calculated according to Equation 4, where SR_{UP} is the value from step 301.

JTH_{UP}=max((L**−SR_{UP}, 0) Equation 4:

In step 307, module 142 calculates a value for MC1 _{UP}=SR_{UP}+JTD_{UP}+JTH_{UP}.

Returning to FIG. 2, module 142 calculates a value for margin component MC1_{DN} in step 207 using a second set of one or more algorithms and based on the PF positions. Margin component MC1_{DN} is also calculated in USD. FIG. 3B shows operations of step 207 according to some embodiments. In step 351, module 142 calculates a value for a spread risk component SR_{DN} for the PF positions by performing an algorithm that is the same as that of step 301, except that an exchange rate of FX_{EURUSD}_{_}_{DN} is assumed instead of FX_{EURUSD}_{_}_{UP}. In step 353, module 142 calculates a value for a jump-to-default component JTD_{DN} for the PF positions by performing an algorithm that is similar to that of step 303, except that an exchange rate of FX_{EURUSD}_{_}_{DN} is assumed instead of FX_{EURUSD}_{_}_{UP}, and a value of SR_{DN} from step 351 is used instead of SR_{UP} from step 301. In step 355, module 142 calculates a value for a jump-to-health component JTH_{DN} for the PF positions by performing an algorithm that is similar to that of step 305, except that an exchange rate of FX_{EURUSD}_{_}_{DN} is assumed instead of FX_{EURUSD}_{_}_{UP}, and a value of SR_{DN} from step 351 is used instead of SR_{UP} from step 301. In step 357, module 142 calculates a value for MC1_{DN}=SR_{DN}+JTD_{DN}+JTH_{DN}.

Returning to FIG. 2, module 142 calculates a value for a margin component MC1 in step 209 by setting MC1 equal to the maximum of MC1_{UP} and MC1_{DN}, i.e., MC1=max(MC1_{UP},MC1_{DN}).

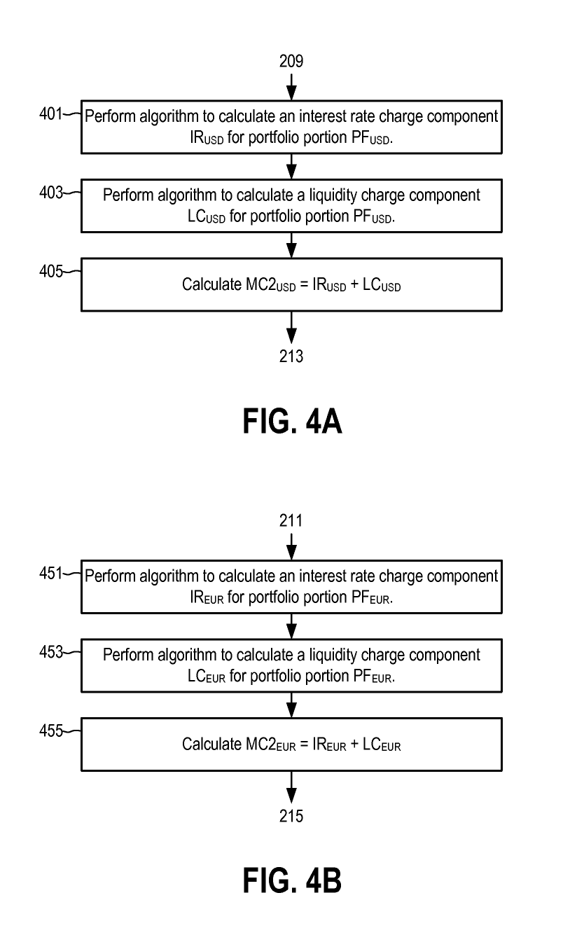

In step 211, module 142 performs a third set of one or more algorithms and calculates a value for a margin component MC2_{USD}. Module 142 calculates a value for MC2_{USD} in USD based on the PF_{USD} positions. FIG. 4A shows operations of step 211 according to some embodiments.

In step 401, module 142 performs an algorithm to calculate a value for an interest rate charge component IR_{USD} for portfolio portion PF_{USD}. Interest rate charge IR_{USD} accounts for possible losses associate with changes in an applicable discount curve structure over a designated period (e.g., 5 days). In some embodiments, the ISDA (International Swaps and Derivatives Association) discount curve for USD is used, an upward shift of the curve is assumed, and a resulting change in value of portfolio portion PF_{USD} (Δᵤₚ) is calculated. Next, a downward shift of the curve is assumed, and a resulting change in value of portfolio portion PF_{USD} (Δ_{dn}) is calculated. Whichever of Δᵤₚ and Δ_{dn} represents a greater loss is then used as the value of IR_{USD}. The magnitudes of the upward and downward shifts are taken to be the 99% quantile of the 5-day log returns for the 5-year point on the ISDA curve, with the quantiles estimated using empirical quantiles based on a 5 year look back period from the date of calculating IR_{USD}.

In step 403, module 142 performs an algorithm to calculate a value for a liquidity charge component LC_{USD} for portfolio portion PF_{USD}. The liquidity charge accounts for extra cost that may be incurred to liquidate portfolio portion PF_{USD} if position sizes are large relative to market depth of corresponding products. In some embodiments, the algorithm of step 403 first breaks up positions in portfolio portion PF_{USD} into additional subportfolios based on the types of corresponding CDS products. For example, one subportfolio may include positions in IG (investment grade) index CDS products, another subportfolio may include positions in HY (high yield) index CDS products, etc. For each subportfolio, a corresponding total exposure is calculated and a corresponding liquid product is identified. With regard to index CDS products for example, the most recent (or “on-the-run”) product tends to be very liquid, while older (or “off-the-run”) products tend have less liquidity. In some embodiments, the on-the-run 5-year CDS product corresponding to the subportfolio is chosen as the liquid product for that subportfolio.

For each subportfolio, the algorithm of step 403 then determines the amount of the corresponding liquid product that would be needed to hedge the corresponding total exposure. The algorithm of step 403 then compares that amount to recent trading volume of the corresponding liquid product and calculates a liquidity cost for that subportfolio based on the comparison. If the needed amount of the corresponding liquid product is small relative to the current trading volume, then the liquidity cost may be very small. If the needed amount of the corresponding liquid product is large relative to the current trading volume, then the liquidity cost may be larger. In some embodiments, the relationship between needed amount and recent trading volume may be implemented as a look-up table that assigns a liquidity charge to different ranges of H/V, where H is the amount of liquid product needed to hedge and V is the trading volume of that liquid product.

After calculating a liquidity charge for each subportfolio, the liquidity charges are then summed. The step 403 algorithm then designates that sum as the value of LC_{USD}. In step 405, module 142 calculates MC2_{USD} as the sum of IR_{USD} and LC_{USD}.

Returning to FIG. 2, module 142 calculates a value for a margin component MC2_{EUR} in step 213. Module 142 calculates an MC2_{EUR} value using a fourth set of one or more algorithms and based on the PF_{EUR} positions. Margin component MC2_{EUR} is calculated in EUR. FIG. 4B shows operations of step 213 according to some embodiments. In step 451, module 142 performs an algorithm to calculate a value for an interest rate charge component IR_{EUR} for portfolio portion PF_{EUR}. The algorithm of step 451 may be the same as that of step 401, but the ISDA discount curve for EUR may be used. In step 453, module 142 performs an algorithm to calculate a value for liquidity charge component LC_{EUR} for portfolio portion PF_{EUR}. The algorithm of step 453 may be the same as that of step 403, but the subportfolios will be groupings of EUR denominated CDS products (e.g., iTraxx Europe, iTraxx Europe Crossover) and corresponding liquid instruments will be different. In step 455, module 142 calculates MC2_{EUR} as the sum of IR_{EUR} and LC_{EUR}.

Returning to FIG. 2, module 142 calculates a USD margin requirement MR_{USD} for portfolio PF in step 215. In some embodiments, module 142 calculates a value for MR_{USD} according to Equation 5.

$${MR}_{USD} = MC {2}_{USD} + \frac{MC {1}_{USD}}{MC {1}_{Spot}} * MC 1 \qquad Equation 5$$

In Equation 5, “MC1_{Spot}” is a value calculated in the same manner as MC1_{UP} and MC1_{DN}, but by using FX_{EURUSD}_{_}_{Spot} instead of FX_{EURUSD}_{_}_{UP} or FX_{EURUSD}_{_}_{DN}. Module 142 calculates a EUR margin requirement MR_{EUR} for portfolio PF in step 217. In some embodiments, module 142 calculates a value for MR_{EUR} according to one of Equation 6a or Equation 6b. Equation 6a is used if FX_{EURUSD}_{_}_{UP} was used to calculate MC1 (i.e., if MC1=MC1_{UP}), and Equation 6b is used if FX_{EURUSD}_{_}_{DN} was used to calculate MC1 (i.e., if MC1=MC1_{DN}).

$$\begin{matrix}{MR}_{EUR} = MC {2}_{EUR} + \frac{MC {1}_{EUR} * {FX}_{EURUSD\_Spot}}{MC {1}_{Spot}} * \frac{MC 1}{{FX}_{EURUSD\_UP}} & Equation 6 a \\ {MR}_{EUR} = MC {2}_{EUR} + \frac{MC {1}_{EUR} * {FX}_{EURUSD\_Spot}}{MC {1}_{Spot}} * \frac{MC 1}{{FX}_{EURUSD\_DN}} & Equation 6 b\end{matrix}$$

In step 219, module 142 transmits the values for MR_{USD} and MR_{EUR} to one or more other components of computer system 100. In step 221, those one or more other components may confirm that a member account corresponding to portfolio PF contains sufficient funds in USD and EUR to satisfy the values of MR_{USD} and MR_{EUR}, or that the member has otherwise deposited collateral determined to be equivalent to the combined requirements of MR_{USD} and MR_{EUR}. In some embodiments, for example, computer system 100 may be configured to accept alternative collateral (e.g., other currencies, US Treasury securities, etc.) in lieu of some or all of MR_{USD} and/or MR_{EUR} according to a predefined “haircut” schedule.

In some embodiments, a computer system may perform operations similar to those described above in connection with FIGS. 2-4B for each of multiple multi-currency CDS portfolios. Moreover, such operations may be performed repeatedly (e.g., daily) for each portfolio.

As indicated above, FIGS. 2-4B were described using an example portfolio PF in which the first and second currencies were USD and EUR. In other embodiments, the first and/or the second currencies may be different. Other embodiments may also or alternatively include one or more other variations of the operations described in connection with FIGS. 2-4B. Various steps in FIGS. 2-4B could be rearranged. The margin requirement components described above, e.g., SR, JTD, JTH, IR, and LC components, could be calculated in alternative ways. In some embodiments, a margin requirement may be calculated using one method for portfolio portions denominated in one currency, and may be calculated using a different method for portfolio portions denominated in another currency. In some embodiments, one or more of the components of a margin requirement may be omitted, and/or other components of a margin requirement may be included.

Operations such as those described herein can be extended to multi-currency CDS portfolios that include interests in CDSs denominated in more than two currencies. For example, assume portfolio PF also has a portion PF_{JPY} that includes positions in CDSs denominated in Japanese Yen (JPY). Step 203 could be modified so as to also calculate exchange rates FX_{JPYUSD}_{_}_{UP} and FX_{JPYUSD}_{_}_{DN} in manner similar to that used to calculate FX_{EURUSD}_{_}_{UP} and FX_{EURUSD}_{_}_{DN}. Steps 205 and 207 could be replaced with (i) steps to calculate values for MC1 _{UP/UP} using operations similar to those in steps 301-307 of FIG. 3A, but by assuming an exchange rate of FX_{EURUSD}_{_}_{UP} for the portfolio portion denominated in EUR and FX_{JAPYUSD}_{_}_{UP} for the portfolio portion denominated in JPY, (ii) steps to calculate values for MC1 _{DN/DN} using operations similar to those in steps 301-307 of FIG. 3A, but by assuming an exchange rate of FX_{EURUSD}_{_}_{DN} for the portfolio portion denominated in EUR and FX_{JPYUSD}_{_}_{DN} for the portfolio portion denominated in JPY, (iii) steps to calculate values for MC1 _{UP/DN} using operations similar to those in steps 301-307 of FIG. 3A, but by assuming an exchange rate of FX_{EURUSD}_{_}_{UP} for the portfolio portion denominated in EUR and FX_{JPYUSD}_{_}_{DN} for the portfolio portion denominated in JPY, and (iv) steps to calculate values for MC1_{DN/UP} using operations similar to those in steps 301-307 of FIG. 3A, but by assuming an exchange rate of FX_{EURUSD}_{_}_{DN} for the portfolio portion denominated in EUR and FX_{JPYUSD}_{_}_{UP} for the portfolio portion denominated in JPY. Step 209 could be modified to calculate MC1=max (MC1_{UP/UP}, MC1_{DN/DN}, MC1_{UP/DN}, MC1_{DN/UP}).

A set of steps similar to those of FIGS. 4A and 4B could be added to calculate a margin component MC2_{JPY} using applicable discount curves, appropriate liquid products, etc. A JPY margin requirement MR_{JPY} could then be calculated using one of Equations 7a or 7b, depending on whether FX_{JPYUSD}_{_}_{UP} or FX_{JPYUSD}_{_}_{DN} was used to obtain MC1.

$$\begin{matrix}{MR}_{JPY} = MC {2}_{JPY} + \frac{MC {1}_{JPY} * {FX}_{JPYUSD\_Spot}}{MC {1}_{Spot}} * \frac{MC 1}{{FX}_{JPYUSD\_UP}} & Equation 7 a \\ {MR}_{JPY} = MC {2}_{JPY} + \frac{MC {1}_{JPY} * {FX}_{JPYUSD\_Spot}}{MC {1}_{Spot}} * \frac{MC 1}{{FX}_{JPYUSD\_DN}} & Equation 7 b\end{matrix}$$

Embodiments such as those described herein may provide several advantages. Effects of potential FX rate fluctuation are included as a risk component in overall margin requirement calculation. By separating a margin requirement into portions denominated in separate currencies, a portfolio holder may have the option of providing security in multiple currencies, thereby potentially obtaining a discount representing overall margin requirement attributable to conversion of one currency into another. For holders of portfolios that only involve a single currency, the above described methodology results in a margin requirement only denominated in that single currency.

### Conclusion

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
accessing, by a computer system, data describing positions of a multi-currency credit default swap (CDS) portfolio PF, the portfolio PF including a portfolio portion PF₁ comprising positions in CDS products denominated in a first currency and a portfolio portion PF₂ comprising positions in CDS products denominated in a second currency;
calculating, by the computer system, based on the accessed data, and based on an exchange rate FX₂₁_{_}_{UP} for converting the second currency to the first currency, a first margin component in the first currency;
calculating, by the computer system, based on the accessed data, and based on an exchange rate FX₂₁_{_}_{DN} for converting the second currency to the first currency, a second margin component in the first currency, wherein FX₂₁_{_}_{UP} is greater than FX₂₁_{_}_{DN};
calculating, by the computer system, a margin component MC1 as a maximum of a set of values that includes the first margin component and the second margin component;
calculating, by the computer system and based on the accessed data, a margin component MC2₁ in the first currency;
calculating, by the computer system based on the accessed data, a margin component MC2₂ in the second currency;
calculating, by the computer system, a first currency margin requirement MR₁ as a sum of the margin component MC2₁ and a portion of the margin component MC1 corresponding to the portfolio portion PF₁;
calculating, by the computer system, a second currency margin requirement MR₂ as a sum of the margin component MC2₂ and a portion of the margin component MC1 corresponding to the portfolio portion PF₂; and
transmitting, by the computer system, data representing the first currency margin requirement MR₁ and the second currency margin requirement MR₂.

2. The method of claim 1, wherein the margin component MC1 comprises a spread risk component, a jump-to-default component, and a jump-to-heath component.

3. The method of claim 2, wherein the margin component MC2₁ and the margin component MC2₂ each comprises an interest rate component and a liquidity charge component.

4. The method of claim 1, wherein the margin component MC2₁ and the margin component MC2₂ each comprises an interest rate component and a liquidity charge component.

5. The method of claim 1, wherein the portfolio PF includes a portfolio portion PF₃ comprising positions in CDS products denominated in a third currency, wherein calculating the first margin requirement comprises calculating based on an exchange rate FX₃₁_{_}_{UP} for converting the third currency to the first currency; wherein calculating the second margin requirement comprises calculating based on an exchange rate FX₃₁_{_}_{DN} for converting the third currency to the first currency, wherein FX₃₁_{_}_{UP} is greater than FX₃₁_{_}_{DN}, wherein calculating margin component MC1 comprises calculating margin component MC1 as a maximum of a set of values that includes the first margin component, the second margin component, a third margin component, and a fourth margin component, and wherein transmitting data representing the first currency margin requirement MR₁ and the second currency margin requirement MR₂ includes transmitting data representing a third currency margin requirement MR₃, and further comprising
calculating, by the computer system, based on the accessed data, and based on the exchange rates FX₂₁_{_}_{UP} and FX₃₁_{_}_{DN}, the third margin component in the first currency;
calculating, by the computer system, based on the accessed data, and based on the exchange rates FX₂₁_{_}_{DN} and FX₃₁_{_}_{UP}, the fourth margin component in the first currency;
calculating, by the computer system based on the accessed data, a margin component MC2₃ in the third currency; and
calculating, by the computer system, the third currency margin requirement MR₃ as a sum of the margin component MC2₃ and a portion of the margin component MC1 corresponding to the portfolio portion PF₃.

6. One or more non-transitory computer-readable media storing computer executable instructions that, when executed, cause a computer system to perform operations that include:
accessing data describing positions of a multi-currency credit default swap (CDS) portfolio PF, the portfolio PF including a portfolio portion PF₁ comprising positions in CDS products denominated in a first currency and a portfolio portion PF₂ comprising positions in CDS products denominated in a second currency;
calculating, based on the accessed data and on an exchange rate FX₂₁_{_}_{UP} for converting the second currency to the first currency, a first margin component in the first currency;
calculating, based on the accessed data and on an exchange rate FX₂₁_{_}_{DN} for converting the second currency to the first currency, a second margin component in the first currency, wherein FX₂₁_{_}_{UP} is greater than FX₂₁_{_}_{DN};
calculating a margin component MC1 as a maximum of a set of values that includes the first margin component and the second margin component;
calculating, based on the accessed data, a margin component MC2₁ in the first currency;
calculating, based on the accessed data, a margin component MC2₂ in the second currency;
calculating a first currency margin requirement MR₁ as a sum of the margin component MC2₁ and a portion of the margin component MC1 corresponding to the portfolio portion PF₁;
calculating a second currency margin requirement MR₂ as a sum of the margin component MC2₂ and a portion of the margin component MC1 corresponding to the portfolio portion PF₂; and
transmitting data representing the first currency margin requirement MR₁ and the second currency margin requirement MR₂.

7. The one or more non-transitory computer-readable media of claim 6, wherein the margin component MC1 comprises a spread risk component, a jump-to-default component, and a jump-to-heath component.

8. The one or more non-transitory computer-readable media of claim 7, wherein the margin component MC2₁ and the margin component MC2₂ each comprises an interest rate component and a liquidity charge component.

9. The one or more non-transitory computer-readable media of claim 6, wherein the margin component MC2₁ and the margin component MC2₂ each comprises an interest rate component and a liquidity charge component.

10. The one or more non-transitory computer-readable media of claim 6, wherein the portfolio PF includes a portfolio portion PF₃ comprising positions in CDS products denominated in a third currency, wherein calculating the first margin requirement comprises calculating based on an exchange rate FX₃₁_{_}_{UP} for converting the third currency to the first currency; wherein calculating the second margin requirement comprises calculating based on an exchange rate FX₃₁_{_}_{DN} for converting the third currency to the first currency, wherein FX₃₁_{_}_{UP} is greater than FX₃₁_{_}_{DN}, wherein calculating margin component MC1 comprises calculating margin component MC1 as a maximum of a set of values that includes the first margin component, the second margin component, a third margin component, and a fourth margin component, and wherein transmitting data representing the first currency margin requirement MR₁ and the second currency margin requirement MR₂ includes transmitting data representing a third currency margin requirement MR₃, and wherein the executable instructions include instructions that, when executed, cause a computer system to perform operations that include
calculating, based on the accessed data and on the exchange rates FX₂₁_{_}_{UP} and FX₃₁_{_}_{DN}, the third margin component in the first currency;
calculating, based on the accessed data and on the exchange rates FX₂₁_{_}_{DN} and FX₃₁_{_}_{UP}, the fourth margin component in the first currency;
calculating, based on the accessed data, a margin component MC2₃ in the third currency; and
calculating the third currency margin requirement MR₃ as a sum of the margin component MC2₃ and a portion of the margin component MC1 corresponding to the portfolio portion PF₃.

11. A computer system comprising:
at least one processor; and
at least one non-transitory memory, wherein the at least one non-transitory memory stores instructions that, when executed, cause the computer system to perform operations that include
accessing data describing positions of a multi-currency credit default swap (CDS) portfolio PF, the portfolio PF including a portfolio portion PF₁ comprising positions in CDS products denominated in a first currency and a portfolio portion PF₂ comprising positions in CDS products denominated in a second currency,
calculating, based on the accessed data and on an exchange rate FX₂₁_{_}_{UP} for converting the second currency to the first currency, a first margin component in the first currency,
calculating, based on the accessed data and on an exchange rate FX₂₁_{_}_{DN} for converting the second currency to the first currency, a second margin component in the first currency, wherein FX₂₁_{_}_{UP} is greater than FX₂₁_{_}_{DN},
calculating a margin component MC1 as a maximum of a set of values that includes the first margin component and the second margin component,
calculating, based on the accessed data, a margin component MC2₁ in the first currency,
calculating, based on the accessed data, a margin component MC2₂ in the second currency,
calculating a first currency margin requirement MR₁ as a sum of the margin component MC2₁ and a portion of the margin component MC1 corresponding to the portfolio portion PF₁,
calculating a second currency margin requirement MR₂ as a sum of the margin component MC2₂ and a portion of the margin component MC1 corresponding to the portfolio portion PF₂, and
transmitting data representing the first currency margin requirement MR₁ and the second currency margin requirement MR₂.

12. The computer system of claim 11, wherein the margin component MC1 comprises a spread risk component, a jump-to-default component, and a jump-to-heath component.

13. The computer system of claim 12, wherein the margin component MC2₁ and the margin component MC2₂ each comprises an interest rate component and a liquidity charge component.

14. The computer system of claim 11, wherein the margin component MC2₁ and the margin component MC2₂ each comprises an interest rate component and a liquidity charge component.

15. The computer system of claim 11, wherein the portfolio PF includes a portfolio portion PF₃ comprising positions in CDS products denominated in a third currency, wherein calculating the first margin requirement comprises calculating based on an exchange rate FX₃₁_{_}_{UP} for converting the third currency to the first currency; wherein calculating the second margin requirement comprises calculating based on an exchange rate FX₃₁_{_}_{DN} for converting the third currency to the first currency, wherein FX₃₁_{_}_{UP} is greater than FX₃₁_{_}_{DN}, wherein calculating margin component MC1 comprises calculating margin component MC1 as a maximum of a set of values that includes the first margin component, the second margin component, a third margin component, and a fourth margin component, and wherein transmitting data representing the first currency margin requirement MR₁ and the second currency margin requirement MR₂ includes transmitting data representing a third currency margin requirement MR₃, and wherein the executable instructions include instructions that, when executed, cause a computer system to perform operations that include
calculating, based on the accessed data and on the exchange rates FX₂₁_{_}_{UP} and FX₃₁_{_}_{DN}, the third margin component in the first currency;
calculating, based on the accessed data and on the exchange rates FX₂₁_{_}_{DN} and FX₃₁_{_}_{UP}, the fourth margin component in the first currency;
calculating, based on the accessed data, a margin component MC2₃ in the third currency; and
calculating the third currency margin requirement MR₃ as a sum of the margin component MC2₃ and a portion of the margin component MC1 corresponding to the portfolio portion PF₃.
